(19) United States
(12) Patent Application Publication
(10) Pub. No.: US 2008/0046384 A1
(43) Pub. Date: Feb. 21, 2008

(54) Postage verification apparatus and methods

(75) Inventors: John F. Braun, Fairfield, CT (US); Robert A. Cordery, Danbury, CT (US); Bradley R. Hammell, Fairfield, CT (US); Douglas B. Quine, Bethel, CT (US); Jay Reichelsheimer, Shelton, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/499,617

(22) Filed: Aug. 4, 2006

(51) Int. Cl. G06F 17/00

(52) U.S. Cl. 705/401

(57) ABSTRACT

A postage verification apparatus includes a reading device for reading a luminescent signature of a postage stamp to detect a value of the postage stamp. The apparatus also includes a weighing device for weighing a mailpiece to which the postage stamp is affixed. Further, the apparatus includes a processing device which is responsive to the reading device and the weighing device. The processing device is for determining whether a required amount of postage has been affixed to the mailpiece.

### CROSS-REFERENCE TO RELATED APPLICATION

This patent application is related to application Ser. No. ______, filed on the same date as this application (Attorney Docket no. G-195), entitled “Postage Stamps Having Values Thereof Luminescently Encoded Thereon and Methods of Reading Such Stamps”, which is incorporated herein by reference.

### BACKGROUND

This invention relates generally to protection of postal revenue, and more particularly to production and machine-reading of postage stamps.

Only a minority of mailpieces carried by the U.S. Postal Service (USPS) are paid for by adhesive postage stamps affixed to the mailpieces. However, in absolute terms the amount of postal revenue generated from adhesive stamps is enormous. To a considerable extent, the USPS relies on voluntary compliance by mailers with published requirements for the amount of postage to be paid for individual mailpieces; the USPS's methods for detecting short-payment of postage are rather casual, relying largely on the delivering mail carrier to note when a mailpiece is overweight and/or oversize for the amount of postage affixed to the mailpiece. To encourage continued widespread voluntary compliance with postage requirements it may be desirable for the USPS (and/or other postal authorities) to establish more systematic systems for detecting short payment of postage.

Most postage stamps issued by the USPS carry luminescent markings. The luminescent markings aid automated canceling equipment to find the stamps so that the stamps can be canceled by the canceling equipment. The luminescent markings also may have a role in detecting and/or deterring counterfeiting of postage stamps. When a counterfeit stamp lacks luminescence, canceling equipment which processes the mailpiece to which the counterfeit stamp is affixed may note the absence of any luminescent corner to the mailpiece, and so may outsort the mailpiece, possibly leading to examination and detection of the counterfeit stamp. However, it is expected that, in the near future, computer printers intended for the consumer market may include the capability of printing luminescent ink. Such a development may make it easier for stamp counterfeiters to apply luminescent markings to counterfeit stamps, and accordingly may reduce the value of luminescent marking of legitimate stamps as a deterrent to counterfeiting.

### SUMMARY

According to an aspect of the invention, a postage verification apparatus includes a reading device for reading a luminescent signature of a postage stamp to detect a value of the postage stamp, a weighing device for weighing a mailpiece to which the postage stamp is affixed, and a processing device, responsive to the reading device and the weighing device, for determining whether a required amount of postage has been affixed to the mailpiece.

As used herein and in the appended claims, a “luminescent signature” of a postage stamp refers to a pattern of luminescent radiation emitted from the postage stamp in one or more discrete wavelength bands.

The luminescent signature of the postage stamp may include a coded representation of the value of the postage stamp. The coded representation may include a binary code.

The reading device may detect that the postage stamp exhibits luminescence in at least one wavelength band and that the postage stamp does not exhibit luminescence in at least one other wavelength band.

The postage verification apparatus may further include a measuring device for detecting at least one dimension of the mailpiece. The processing device may be responsive to the measuring device in determining whether the required amount of postage has been affixed to the mailpiece.

As used herein and in the appended claims, detecting or measuring a dimension of a mailpiece may include either or both of (a) determining a length of the dimension in terms of standard length units, and (b) determining whether the dimension is longer or shorter than a benchmark length. It should further be understood that any dimension, whether commonly denoted as the length, width or thickness/depth of a mailpiece, may be said to have a “length” as an attribute.

The postage verification apparatus may also include an address reading device for reading at least a portion of an address field on the mailpiece. The processing device may determine whether the required amount of postage has been affixed to the mailpiece based in part on address information generated by the address reading device.

In another aspect of the invention, a method is provided which includes reading a luminescent signature of a postage stamp to detect a value of the postage stamp. The method further includes weighing a mailpiece to which the postage stamp is affixed to determine a weight of the mailpiece, and determining, based at least in part on the detected value of the postage stamp and the weight of the mailpiece, whether a required amount of postage has been affixed to the mailpiece.

The method may further include measuring at least one dimension of the mailpiece. The determination of whether the required amount of the postage has been affixed may be based in part on the measured at least one dimension of the mailpiece.

The reading step may include examining the postage stamp for the presence or absence of luminescence in each of a plurality of wavelength bands.

The method may further include reading at least a portion of an address field on the mailpiece. The determination of whether the required amount of postage has been affixed may be based in part on information read from the address field.

In still another aspect of the invention, a postage verification apparatus includes a transport mechanism for transporting mailpieces seriatim, and an excitation device for applying excitation radiation to postage stamps affixed to the mailpieces. The apparatus further includes a prism for receiving, and dispersing by wavelength, multispectral luminescence radiation emitted by the postage stamps in response to application of the excitation radiation. In addition, the apparatus includes a sensor device for receiving and detecting the multispectral luminescence radiation dispersed by the prism, and a processing device, coupled to the sensor device, for detecting wavelength bands of the multispectral luminescence radiation received by the sensor device.

As used herein and in the appended claims, multispectral luminescence is radiation luminescently and simultaneously emitted in two or more discrete wavelength bands.

The processing device may detect the wavelength bands of the radiation based at least in part on respective locations on the sensor device at which the dispersed multispectral luminescence radiation is received. The apparatus may further include a mechanism for rotating the prism. In addition, the apparatus may include a mechanism for detecting an instantaneous rotational position of the prism.

Still further, the apparatus may include a weighing device, coupled to the processing device, for weighing the mailpieces and for supplying weight data to the processing device. The weight data may represent respective weights of the mailpieces. The processing device may be operative to detect values of the postage stamps based on the detected wavelength bands of the radiation, and to determine, based at least in part on the weight data and the detected values of the postage stamps, whether required amounts of postage have been affixed to the mailpieces.

In addition, the apparatus may include a measuring device, coupled to the processing device, for detecting at least one dimension of the mailpieces. The processing device may determine whether required amounts of postage have been affixed to the mailpieces based in part on the detected at least one dimension of the mailpieces.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 shows a mailpiece provided according to some embodiments of the invention.

FIG. 2 shows a scheme for encoding postage stamp value by luminescence wavelength band with binary encoding in accordance with some embodiments of the invention.

FIG. 3 shows another scheme for encoding postage stamp value by luminescence wavelength band in accordance with some embodiments of the invention.

FIG. 4 is a schematic block diagram representation of a postage verification apparatus provided in accordance with some embodiments of the invention.

FIG. 5 is a flow chart that illustrates a process that may be performed by the postage verification apparatus of FIG. 4.

FIG. 6 is a schematic illustration of features of certain embodiments of a luminescence reading component of the postage verification apparatus of FIG. 4.

FIG. 6A is a schematic illustration of features of an alternative embodiment of a luminescence reading component of the postage verification apparatus of FIG. 4.

FIG. 6B is a schematic mapping of a sensor that is part of the luminescence reading component of FIG. 6A.

FIGS. 7 and 8 graphically illustrate two different luminescent radiation patterns that may be produced in response to different excitation radiation wavelengths by a multispectral ink provided in accordance with aspects of the present invention.

### DETAILED DESCRIPTION

The present invention, in its various aspects, allows for automatic verification by machine of the correctness of the amount of postage affixed to mailpieces. The values of postage stamps may be encoded thereon for machine reading by use of multispectral luminescent inks on the postage stamps. The values of the stamps may be represented in coded form by narrow discrete wavelength bands in which the inks luminescently emit radiation after proper excitation by a UV source or a source of other radiation, which may be visible radiation. An automated postage verification device detects the wavelength bands of the luminescent emissions to detect the postage stamp values. The postage verification device may also automatically weigh and/or measure dimensions of the mailpiece and may perform a rating calculation to determine the appropriate amount of postage required for the mailpieces. Under-payment of postage may be detected when the postage verification device determines that the detected value of the affixed postage stamps or stamps is less than the required amount of postage as indicated by the rating calculation.

Moreover, the narrow discrete wavelength band or bands luminescently emitted by legitimate stamps may be difficult for counterfeiters to duplicate. Luminescent signatures of this type may be produced by quantum dots, luminescent nanospheres and/or rare-earth doped particles. Such materials may be difficult for counterfeiters to obtain (for example such materials may be tightly controlled) and may present a significant barrier to unauthorized production of postage stamps.

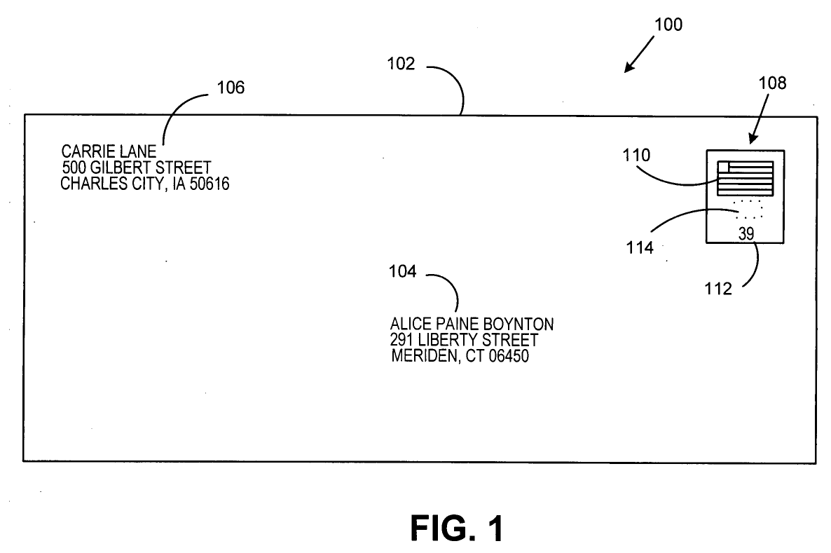

FIG. 1 shows a mailpiece 100 provided according to some embodiments of the invention. In this example, the mailpiece includes a number 10 business envelope 102, which carries printed recipient address information in a recipient address field 104 and return address information in a return address field 106. In addition, the mailpiece 100 has affixed thereto a postage stamp 108 provided in accordance with aspects of the present invention. The postage stamp 108 includes a decorative image 110, a human-readable indication 112 of the denomination (value) of the stamp, and a region 114 in which a specialized (e.g., multispectral or narrow-band) luminescent ink is printed on the stamp 108. The specialized luminescent ink is provided in accordance with the invention to encode in machine-readable form, with one or more emission wavelength bands, the value of the postage stamp 108. In some embodiments, the human-readable indication 112 may also be printed in a narrow-band/multispectral luminescent ink to allow for visual confirmation of the automatic stamp denomination sensing described below. For example, wavelength bands of the special ink may be selected so that the human-readable indication is red for a 39 cent stamp, green for a 24 cent stamp, and blue for a 63 cent stamp. Many other examples are possible.

The present invention contemplates a number of different schemes for using the luminescent emission wavelength bands of the specialized ink to encode the stamp value. To maximize the code “alphabet”, it may be desirable to define relatively narrow discrete wavelength bands, such as bands having a bandwidth less than or equal to about 50 nm. Preferably the bandwidth of each band is less than about 30 nm and still more preferably is about 20 nm. Currently existing techniques for generating luminescent taggants with one or more of quantum dots, luminescent nanospheres and rare-earth doped particles allow for definition of emissions in discrete wavelength bands as narrow as 20 nm. Examples of inks including such taggants are disclosed in the following co-pending and commonly assigned U.S. patent applications, which are incorporated herein by reference:

(A) “Luminescent Ink”, application Ser. No. 11/166,887, filed Jun. 24, 2005, attorney docket no. F-978;

(B) “Combined Multi-Spectral Document Markings”, application Ser. No. 11/290,728, filed Nov. 30, 2005, attorney docket no. F-948.

In some embodiments, the special ink may have the property of showing different colors depending on the angle from which it is viewed. Inks having this property are conventionally employed in printing paper currency.

According to some embodiments of the present invention, the specialized ink printed in region 114 may include two or more taggants so as to emit luminescent radiation in two or more discrete wavelength bands. Accordingly, the specialized ink may be considered to be “multispectral”. As noted in the above-referenced co-pending patent applications, the specialized ink may be invisible to the naked eye. In such a case, it may be desirable for the region 114 to overlap, partially or entirely, with a visible feature of the postage stamp 108.

With wavelength bands as narrow as 20 nm, it may be practical define as many as 30 discrete wavelength bands for encoding purposes, covering the visible and infrared portions of the spectrum. The actual number of wavelength bands used for value encoding and other purposes may be equal to, smaller or larger than 30.

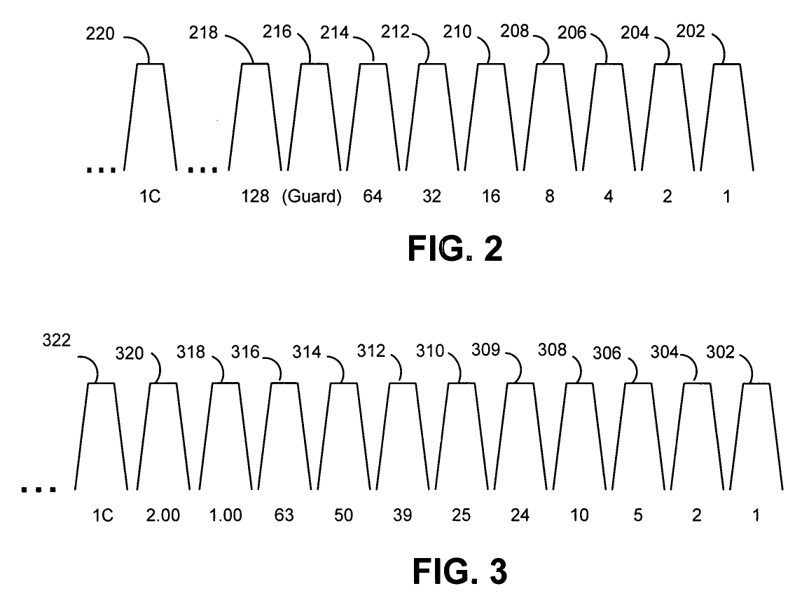

At least some of the wavelength bands may be assigned binary numbering place values so as to allow the presence or absence of luminescence in a given wavelength band to indicate a “1” or “0” value for a bit in a binary number that represents the value of the postage stamp in cents. An example of such a postage stamp value encoding scheme is schematically illustrated in FIG. 2.

In FIG. 2, the wavelength band indicated at 202 represents the “one” place value in the binary representation of the postage stamp value; the wavelength band indicated at 204 represents the “two” place value in the binary representation of the postage stamp value; the wavelength band indicated at 206 represents the “four” place value in the binary representation of the postage stamp value; the wavelength band indicated at 208 represents the “eight” place value in the binary representation of the postage stamp value; the wavelength band indicated at 210 represents the “sixteen” place value in the binary representation of the postage stamp value; the wavelength band indicated at 212 represents the “thirty-two” place value in the binary representation of the postage stamp value; and the wavelength band indicated at 214 represents the “sixty-four” place value in the binary representation of the postage stamp value.

The wavelength band indicated at 216 may be used as a “guard” band, which is a wavelength band in which none of the postage stamps emits luminescent radiation. The guard band 216 may be employed so that there is always at least one wavelength band in which there is no luminescent emission. This allows reading equipment to detect that the luminescent signature of the postage stamp is not simply that of a wideband luminescent emitting ink, such as the inks commonly used in conventional postage stamps. The guard band 216 may be located at another place in the spectrum (than as illustrated in FIG. 2), relative to the place value wavelength bands (e.g., between any two of the place value wavelength bands).

The wavelength band indicated at 218 represents the “one-hundred-twenty eight” place value in the binary representation of the postage stamp value. Additional power-of-two place value wavelength bands may be defined. Moreover, the number of binary place value wavelength bands may be fewer than the eight such bands explicitly shown in FIG. 2.

In some embodiments, the multispectral ink for the stamp 108 (FIG. 1) may be formulated to indicate the stamp's value of 39 cents, by emitting luminescent radiation in, and only in, the wavelength bands 212, 206, 204 and 202, to indicate “1” bits in the “thirty-two”, “four”, “two” and “one” value places, corresponding to the number 39 expressed in the binary number system. In other embodiments, the ink may be formulated to emit luminescent radiation in these bands and in one or more additional bands (not indicated in FIG. 2) which may be used to confirm the validity of the stamp's luminescent signature.

In other embodiments, so-called inverse logic may be employed, so that failure to emit luminescent radiation in a given place value wavelength band represents a “1” bit value for the corresponding binary number place value. One or more guard bands may be provided for such a scheme, with luminescent emission always occurring in such guard band or bands.

In some encoding schemes, a wavelength band 220 may be reserved to allow for indication that the stamp's denomination is a “forever” (i.e., perpetually valid) first class denomination. In such a “forever” denomination, a first class stamp purchased at the current one-ounce first class price will be honored perpetually to mail a one-ounce letter first class, even after one or more rate increases may occur. With such a scheme, the specialized ink may emit luminescent radiation only in the wavelength band 220 to indicate that the stamp in question is a “forever first class” stamp. In some embodiments, to aid in deterring counterfeiting, the ink may also emit luminescent radiation in one or more additional wavelength bands (which are not indicated) in order to indicate the year in which the stamp was produced. Whether or not the luminescent signature of the ink/stamp is formulated to indicate year of production, there may be one or more additional wavelength bands (not shown) in which the ink emits luminescent radiation, in addition to the “forever first class” indicator wavelength band, to confirm the validity of the stamp's luminescent signature.

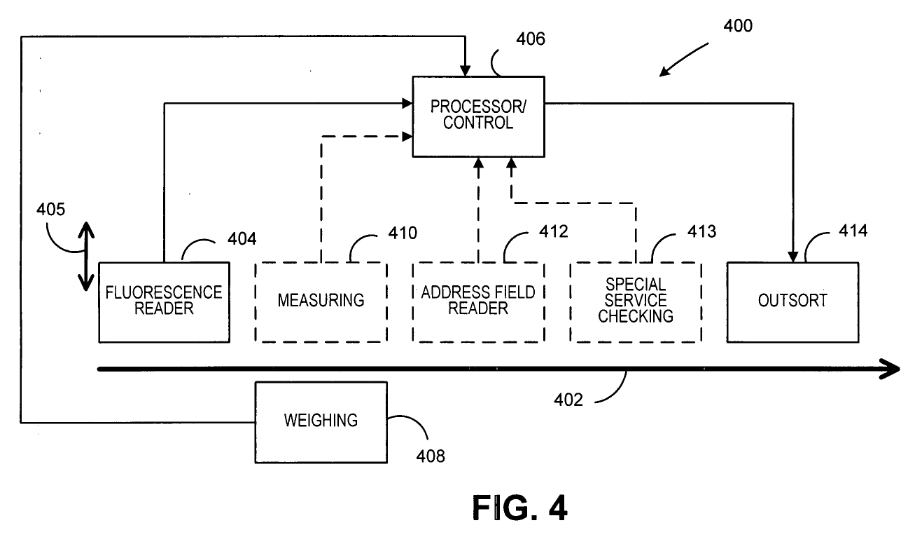

FIG. 3 schematically illustrates another, simpler but less flexible, encoding scheme that may be employed for indicating postage stamp values by using luminescent emission wavelength bands. Generally in this case, the various wavelength bands may correspond one-to-one with particular stamp denominations. In this encoding scheme, the specialized ink need not be multispectral, but rather may emit luminescent radiation only in a single narrow wavelength band.

In the particular embodiment illustrated in FIG. 3, the wavelength band indicated at 302 may be reserved to indicate that the denomination of the postage stamp is one cent; the wavelength band indicated at 304 may be reserved to indicate that the denomination of the postage stamp is two cents; the wavelength band indicated at 306 may be reserved to indicate that the denomination of the postage stamp is five cents; the wavelength band indicated at 308 may be reserved to indicate that the denomination of the postage stamp is ten cents; the wavelength band indicated at 309 may be reserved to indicate that the denomination of the postage stamp is 24 cents; the wavelength band indicated at 310 may be reserved to indicate that the denomination of the postage stamp is 25 cents; the wavelength band indicated at 312 may be reserved to indicate that the denomination of the postage stamp is 39 cents; the wavelength band indicated at 314 may be reserved to indicate that the denomination of the postage stamp is 50 cents; the wavelength band indicated at 316 may be reserved to indicate that the denomination of the postage stamp is 63 cents; the wavelength band indicated at 318 may be reserved to indicate that the denomination of the postage stamp is one dollar; the wavelength band indicated at 320 may be reserved to indicate that the denomination of the postage stamp is two dollars; and the wavelength band indicated at 322 may be reserved to indicate that the denomination of the postage stamp is “forever first class” (as explained above).

Thus, for example, in this encoding scheme, the specialized ink applied to a 39 cent stamp may luminesce only in wavelength band 312. Alternatively, the specialized ink may be multispectral and may also fluoresce in one or more additional wavelength bands (not indicated in FIG. 3) to confirm the validity of the stamp's luminescent signature.

It will be noted that the denominations supported by the encoding scheme of FIG. 3 include 39 cents, which is the current first class stamp (one ounce) denomination, 63 cents, which is the current first class rate for a two-ounce letter, and 24 cents, which is the amount due for the “second ounce” (a 24 cent stamp may be affixed to a mailpiece together with a 39 cent stamp to pay for postage if the mailpiece is over one ounce in weight but not over two ounces). Assuming (as we must) that the first class rate for a one-ounce letter will be raised sooner or later to, say, 41 cents, it will be understood that the encoding scheme may incorporate further wavelength bands (not explicitly indicated in FIG. 3) to which no denomination is currently assigned but to which a particular additional denomination (e.g., 41 cents) may be assigned in the future.

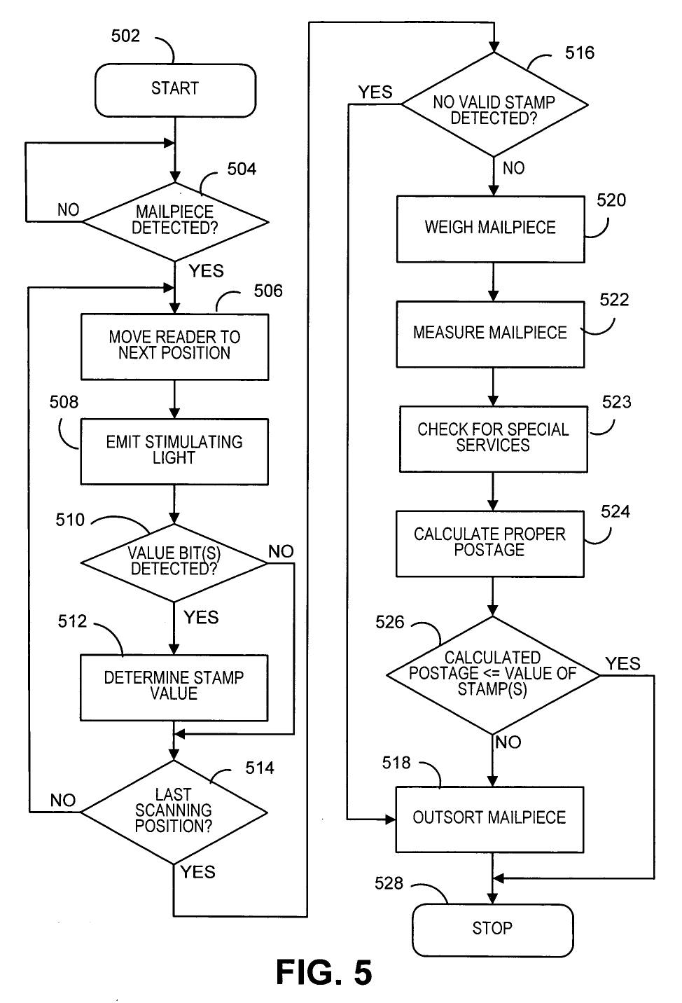

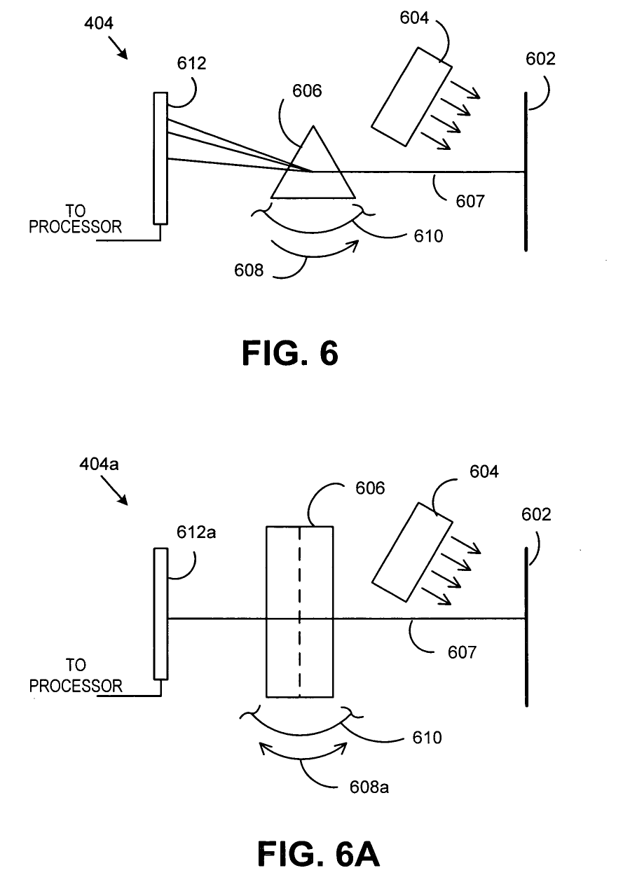

A common attribute of the encoding schemes that have been discussed above is that the schemes may be employed so that the luminescent signature of a postage stamp indicates, by the particular wavelength band or bands in which radiation is emitted, the value and/or denomination of the stamp. As will now be described with reference to FIGS. 4 and 5, producing stamps in such a manner allows for ready detection of the stamp value/denomination by suitable optical equipment. Optical equipment of this type may function to validate the authenticity of stamps and/or may operate in cooperation with other devices to verify that sufficient postage has been applied to mailpieces that carry stamps that have been encoded in this way.

FIG. 4 is a schematic block diagram representation of a postage verification apparatus 400 provided in accordance with some embodiments of the invention.

The postage verification apparatus 400 may include a transport mechanism (schematically represented by arrow mark 402). The transport mechanism 402 may operate to transport mailpieces (not shown in FIG. 4) seriatim past and/or to and/or from other components (which will be described below) of the postage verification apparatus 400. The transport mechanism 402 may operate in accordance with conventional principles and may be suitable for transporting letter-size mailpieces like the mailpiece 100 shown in FIG. 1. In some embodiments, the postage verification apparatus 400 may be partially or completely integrated with machinery (not separately shown), such as a facer/canceller, that performs other functions besides postage verification in a conventional manner. Accordingly, the postage verification apparatus 400 may share the transport mechanism 402 with other machinery.

The postage verification apparatus 400 may also include a luminescent signature reader 404 that is provided in accordance with principles of the present invention. The luminescent signature reader 404 may be positioned adjacent the feed path (not separately shown) of the transport mechanism 402 so as to allow the luminescent signature reader 404 to read the luminescent signatures of postage stamps affixed to mailpieces transported by the transport mechanism. The luminescent signature reader 404 may be able to detect luminescent emissions in discrete wavelength bands of the types discussed above in connection with FIGS. 1-3. In some embodiments, the luminescent signature reader 404 may be constructed in accordance with the teachings of U.S. Pat. No. 6,813,018, issued to Richman. In some embodiments, the luminescent signature reader 404 may include a generally light-tight chamber (not separately shown) through which the mailpiece passes as it is being read to isolate the mailpiece from ambient light. The luminescent signature reader 404 may also include a suitable UV source (not separately shown in FIG. 4) to excite the special luminescent ink on the postage stamp(s) affixed to the mailpiece so that the luminescent ink emits luminescent radiation to be read by the luminescent signature reader 404.

The luminescent signature reader 404 may include suitable filters so that it is able to detect luminescent emissions in narrow wavelength bands. In addition, the luminescent signature reader 404 may detect that no luminescent emissions are present in one or more wavelength bands. Consequently, the luminescent signature reader 404 is able to distinguish the luminescent signature of the postage stamp from wideband luminescent emissions of the type provided by postage stamps in accordance with some conventional practices. In some embodiments, the luminescent signature reader 404 may detect that the postage stamp emits luminescent radiation in one wavelength band while also determining that the postage stamp does not emit luminescent radiation in a wavelength band immediately adjoining the wavelength band in which the luminescent radiation was detected or while also determining that the postage stamp does not emit luminescent radiation in the two wavelength bands immediately on either side of the wavelength band in which the luminescent radiation was detected. In addition or alternatively, the luminescent signature reader 404 may determine that the stamp does not emit luminescent radiation in one wavelength band while also detecting that the stamp emits luminescent radiation in the two wavelength bands immediately on either side of the wavelength band in which it was detected that the stamp emits luminescent radiation.

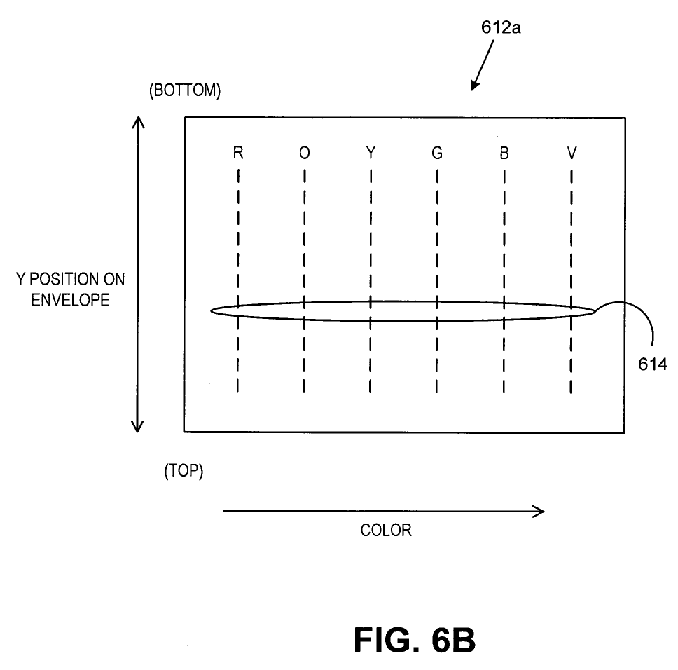

An alternative embodiment of the luminescent signature reader 404 is described below in connection with FIG. 6.

The luminescent signature reader 404 may be adapted to handle issues related to possible variations in the location of a stamp on the mailpiece and/or issues related to the presence of two or more stamps on a mailpiece.

Issues arising from variations in stamp location may be handled, for example, by providing the luminescent signature reader 404 with a capability of scanning a relatively wide area in one pass. However, this attribute may be disadvantageous when it comes to detecting that two or more stamps are affixed to a single mailpiece and detecting the respective values of the stamps. That is because scanning a wide area may cause two or more stamps to be detected at once, in such a way that one or more of the stamps' luminescent signatures are masked and/or the luminescent signatures interfere with each other.

It may therefore be advantageous for the luminescent signature reader 404 to have a relatively small reading area and to cause the luminescent signature reader 404 to scan the mailpiece both in the horizontal and vertical directions (assuming the mailpieces are transported in a vertical orientation). The horizontal scanning direction may be provided by moving the mailpieces along the feed path of the transport mechanism 402. The vertical scanning direction may be provided by a suitable mechanism (schematically represented by two-headed arrow-mark 405) to move the luminescent signature reader 404 up and down. The luminescent signature reader 404 may work quickly enough to scan for luminescence all or a large part of the mailpiece's surface in a short time. The stamps may be laid out in a manner to reduce or eliminate the possibility of detecting two stamps in a single reading cycle. For example, as illustrated in FIG. 1, the luminescent ink may be printed on the stamp only at a central region 114 of the stamp, so that the respective luminescent portions of two adjoining stamps are spaced from each other by a substantial distance.

Another issue that may be addressed by the stamp value encoding system is possible wideband luminescence of the envelopes to which the stamps are affixed. It is not unusual for the paper used to make envelopes to have been previously treated with whitening agents that may cause the papers to exhibit some degree of luminescence. Accordingly, it may be desirable to formulate the special ink or inks used to generate luminescent signatures in accordance with the invention in such a manner that the relative intensity of the luminescent signatures is considerably greater than the background luminescence that may be exhibited by the envelope. Moreover, the luminescent signature reader 404 may operate to disregard luminescent emissions in a wavelength band unless the emissions are at a sufficient level to indicate that a postage stamp's luminescent signature is responsible for the emissions.

The postage verification apparatus 400 also includes a processing/control block 406. The processing/control block 406 may control over-all operation of the postage verification apparatus 400 or of portions of the postage verification apparatus 400. In addition or alternatively, the processing/control block 406 may perform data and/or signal processing and/or data and/or signal interpretation to make determinations as to whether sufficient postage has been affixed to the mailpieces handled by the postage verification apparatus 400. At least in some cases, at least a portion of the functionality ascribed above to the luminescent signature reader 404 may be performed by the processing/control block 406, in that raw or partially processed signals may be passed from the luminescent signature reader 404 to the processing/control block 406 for further processing and/or interpretation.

In some embodiments, the processing/control block 406 may be microprocessor-based, and so may include a microprocessor (not separately shown) coupled to a memory device or devices (not separately shown) which store(s) software and/or firmware to program the microprocessor to provide the functionality described herein.

Among other functions, the processing/control block 406 may operate to control the vertical scanning mechanism 405 for the luminescent signature reader 404. Accordingly, there may be a signal path, which is not shown, provided between the processing/control block 406 and the vertical scanning mechanism 405.

The postage verification apparatus 400 may also include a weighing module 408. The weighing module 408 may be incorporated with the transport mechanism 402 to perform a “weigh-on-the-way” function whereby the weighing module 408 weighs the mailpieces as they are being transported by the transport mechanism 402. The weighing module 408 may operate in accordance with conventional principles. As an alternative to performing “weigh-on-the-way”, the weighing module 408 may operate as a “weigh-on-the-pause” device or may operate as a conventional platform scale with the mailpiece being automatically deposited on the scale platform (not separately shown) before weighing and being automatically removed from the scale platform after weighing. In other embodiments, a human operator may manually place the mailpiece on the weighing module 408.

The weighing module 408 is coupled to the processing/control block 406 to allow the weighing module to provide to the processing/control block 406 weight data that represents the respective weights of the mailpieces weighed by the processing/control block 406.

In some cases, all mailpieces processed by the postage verification apparatus 400 may already have been sorted by size, so that the dimensions of the mailpieces may be known, and need not be measured in order to determine whether sufficient postage has been applied. In other cases, the postage verification apparatus 400 may be adapted to handle mixed-size mail and therefore may include a mailpiece measuring module 410 (shown in phantom). The measuring module 410 may be coupled to the processing/control block 406 and may be associated with the transport mechanism 402. The measuring module 410 may operate to measure/detect one or more dimensions of the mailpieces transported by the transport mechanism 402. For example, the measuring module 410 may operate in accordance with teachings of co-pending and commonly assigned U.S. patent application Ser. No. 11/228,598 entitled,“Method And System For Measuring Thickness Of An Item Based On Imaging”, filed Sep. 16, 2005 (Attorney docket no. F-974), which is incorporated herein by reference. The measuring module 410 may provide, to the processing/control block 406, data that represents a measurement or measurements of the mailpieces measured by the measuring module 410. The processing/control block 406 may take the data from the measuring module 410 into consideration, in addition to or instead of considering the weight data provided by the weighing module 408, in determining what is the amount of postage required for the mailpiece.

Another factor that may advantageously be considered, in some embodiments, in determining the required amount of postage is whether the destination address for the mailpiece is a domestic address or an international address. An address field reader 412 (shown in phantom) may be included in the postage verification apparatus 400 for the purpose of providing input to the processing/control block 406 as to whether the mailpiece is subject to domestic or international postage rates.

Still another factor that may be considered in determining the required postage amount is whether the sender has requested one or more special services such as insured mail services, registered mail services, certified mail services, return receipt, etc. Thus the postage verification apparatus may further include a special services checking module 413 (shown in phantom) which may be embodied as a barcode reader to read a barcode on the mailpiece indicative of the special service or services requested for the mailpiece.

The postage verification apparatus 400 may further include an outsort module 414. The outsort module 414 may be coupled to, and under the control of, the processing/control block 406. The processing/control block 406 may control the outsort module 414 to cause the outsort module 414 to remove from the mail stream mailpieces which the processing/control block determine lack sufficient postage and/or lack entirely any postage stamp with a valid luminescent signature.

The postage verification apparatus 400 may also include one or more sensors (not shown) to detect the arrival of mailpieces and to track the progress of mailpieces through the postage verification apparatus 400. At least some of the sensors may be coupled to the processing/control block 406.

FIG. 5 is a flow chart that illustrates a process that may be performed by the postage verification apparatus 400.

The process starts at 502 and advances to a decision block 504. At decision block 504, the postage verification apparatus 400 determines whether a mailpiece has arrived for processing by the postage verification apparatus 400. If not, the postage verification apparatus 400 idles. However, if the postage verification apparatus detects arrival of a mailpiece, then step 506 follows. At step 506, the luminescent signature reader 404 is moved to its next position (which may be the first scanning position) relative to the mailpiece. Then, at step 508, the luminescent signature reader emits UV light to excite the luminescent ink on the stamp (if present at the current scanning position) on the mailpiece.

In a decision block at 510, the postage verification apparatus 400 determines whether, in response to the UV light, a luminescent signature has been emitted from the mailpiece (presumably from a postage stamp affixed thereto), including one or more emissions in a wavelength band or bands to indicate the value of the stamp. (It may also be determined at this point, in order to rule out the presence of wide-band luminescence, whether emissions are absent from one or wavelength bands, such as a guard band or bands.) If one or more wavelength band emissions are detected at 510 to indicate the denomination of the stamp, then at 512 the postage verification apparatus 400 determines the value of the stamp. Following step 512 (or alternatively directly following decision block 510 if a negative determination is made at decision block 510) is a decision block 514 to determine whether the luminescent signature reader 404 is at its final scanning position. If not, the process loops back to step 506 and the loop 506-514 is repeated.

However, if it is determined at 514 that the luminescent signature reader 404 is at its final scanning position, then decision block 516 follows decision block 514. At decision block 516 it is determined whether a valid stamp (i.e., a valid luminescent signature) was detected in at least one pass through the loop 506-514. If it is the case that no valid stamp was detected, then the process advances to step 518, at which the mailpiece is advanced to outsort module 414 and then removed from the mail stream by the outsort module. The outsorted mailpiece may then receive attention from a postal employee for suitable treatment due to lack of postage or for investigation of a possibly counterfeit stamp.

If it is determined at 516 that at least one valid stamp was detected, then step 520 follows decision block 516. At step 520, the weighing module 408 weighs the mailpiece and provides, to the processing/control block 406, weight data that indicates the weight of the mailpiece. Next (assuming a mailpiece measuring module 410 is present) is step 522, at which at least one dimension of the mailpiece is measured (or at least compared against a benchmark dimensional length) and corresponding data is provided to the processing/control block 406.

Step 523 may follow step 522, if a special service checking module 413 is present. (Alternatively, if step 522 is not performed, step 523 may directly follow step 520.) At step 523, it is determined whether one or more special services have been requested for the mailpiece. This may be done, for example, by reading one or more barcodes on the mailpiece which are indicative of requested special services.

Step 524 follows step 522 (if performed, otherwise step 524 follows step 520). At step 524, the processing/control block determines, based on data provided in steps 520 and/or 522, what is the correct amount of postage that should be affixed to the mailpiece. Then, at decision block 526, the processing/control block determines whether the value of the stamp (or cumulative value of all stamps detected, if more than one was detected) is at least equal to the required amount of postage calculated at 524. If a positive determination is made at 526 (i.e., if a stamp or stamps providing the required amount of postage was (were) detected) then postage verification is complete and the process ends (528) with respect to the current mailpiece. It will be appreciated that the process of FIG. 5 may then begin, or may already be ongoing, with respect to one or more additional mailpieces.

If at decision block 526 it is determined that the required amount of postage was not detected, then the process advances from 526 to 518, at which the outsort module 414 outsorts the mailpiece from the mail stream. A postal employee may then take suitable action with respect to the mailpiece, such as returning it to the sender because of insufficient postage.

Thus the postage verification apparatus 400, operating for example in the manner indicated in FIG. 5, may accomplish large-scale automated verification that proper postage has been affixed to incoming mailpieces. As part of the operation of the postage verification apparatus 400, mailpieces which lack proper postage are shifted out of the mail stream, to allow for efficient and consistent enforcement of postage requirements and encouragement to postal patrons to maintain compliance with postage payment rules. Moreover, the postage verification apparatus 400 may also function as a first line of defense or early warning against counterfeiting of postage stamps.

FIG. 6 is a schematic illustration of features of certain embodiments of the luminescent signature reader 404 of the postage verification apparatus 400.

Reference numeral 602 in FIG. 6 indicates a mailpiece to be scanned by the luminescent signature reader 404. The luminescent signature reader 404 includes a UV source 604 to emit and apply to the mailpiece (or more specifically to one or more postage stamps—not separately shown—which are affixed to the mailpiece) radiation to excite luminescent ink on the stamp to emit the stamp's luminescent signature.

The luminescent signature reader 404 also includes a prism 606 positioned to receive luminescent radiation 607 emitted by the postage stamp in response to excitation from the UV radiation. The prism 606 is mounted for rotation by a motor schematically indicated at 608. Rotation of the prism 606 may effectively allow for vertical-direction scanning of the mailpiece 602. The prism 606 is mounted in association with an optical encoder 610 or the like. The optical encoder may be read by a suitable mechanism (not separately shown) to detect the instantaneous rotational position of the prism 606. The resulting data may be provided to the processing/control block (FIG. 4, not shown in FIG. 5) by a signal path which is not shown.

The luminescent signature reader 404 further includes a sensor 612 such as a CCD (charge coupled device) array positioned to receive and detect radiation which emerges from the prism 606. Because the luminescent signature 607 may include radiation in a number of wavelength bands, the luminescent signature 607 may be dispersed by wavelength by the prism so as to strike the sensor 612 at various locations, each of which may correspond to a respective wavelength band. Because the prism 606 rotates, the wavelength band to which a specific sensor location corresponds varies over time, but may be determined by the processing/control block 406 (FIG. 4, not shown in FIG. 6) based on the present rotational position of the prism 606. The processing/control block may detect the wavelength bands characteristic of the stamp's luminescent signature based on the locations on the sensor 612 at which the radiation from the prism is received.

FIG. 6A is a schematic illustration of features of an alternative embodiment of a luminescence reading component of the postage verification apparatus of FIG. 4. The reader 404a shown in FIG. 6A is different from the reader 404 of FIG. 6 chiefly in that the prism 606 in the reader 404a is oriented with its longitudinal axis perpendicular to the axis of rotation of the prism, rather than parallel (or coincident) to the axis of rotation as in the reader 404. Consequently, the locations for detecting the various wavelength bands may be substantially invariant along a horizontal axis during rotation of the prism, in the reader 404a. In other differences between the readers 404a, 404, the reader 404a may include a two-dimensional sensor array 612a instead of the sensor array 612 of the reader 404, which may be narrow and/or essentially one-dimensional; and the rotation of the prism 606 in reader 404a may be bidirectional, as indicated at 608a, rather than in one (e.g., continuous) direction as in the reader 404.

FIG. 6B is a schematic mapping of the sensor 612a that is part of the luminescence reader 404a shown in FIG. 6A. Referring to FIG. 6B, dashed vertical lines indicate positions of columns in the sensor array 612a, with each column corresponding to a respective wavelength band to be detected by reader 404a. (In practice the actual number of columns/bands to be detected may be considerably greater than the number indicated in the drawing.) Displacement of detected radiation along a column location may correspond (in inverted fashion) to location of the detected ink region in the Y-axis direction on the mailpiece. The detected location of the ink region in the X-axis direction on the mailpiece may be determined as a function of time, as the mailpiece is transported horizontally past the reader.

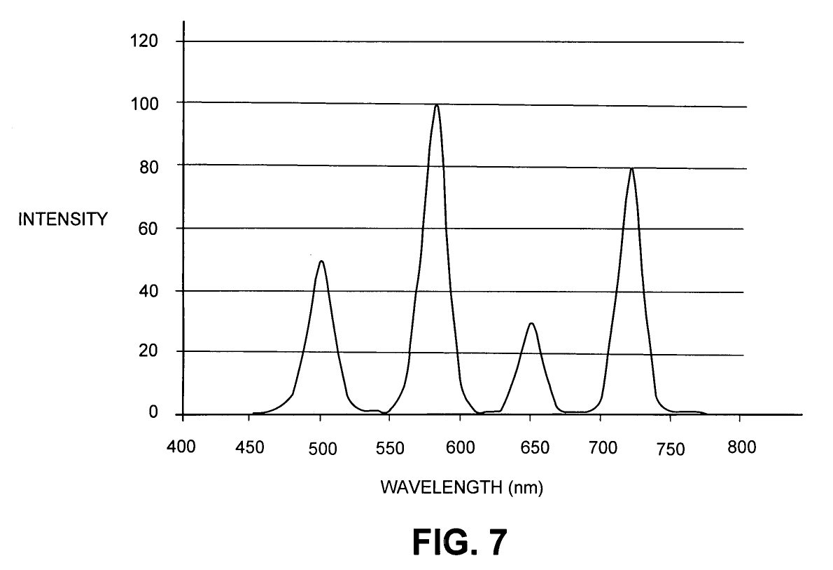

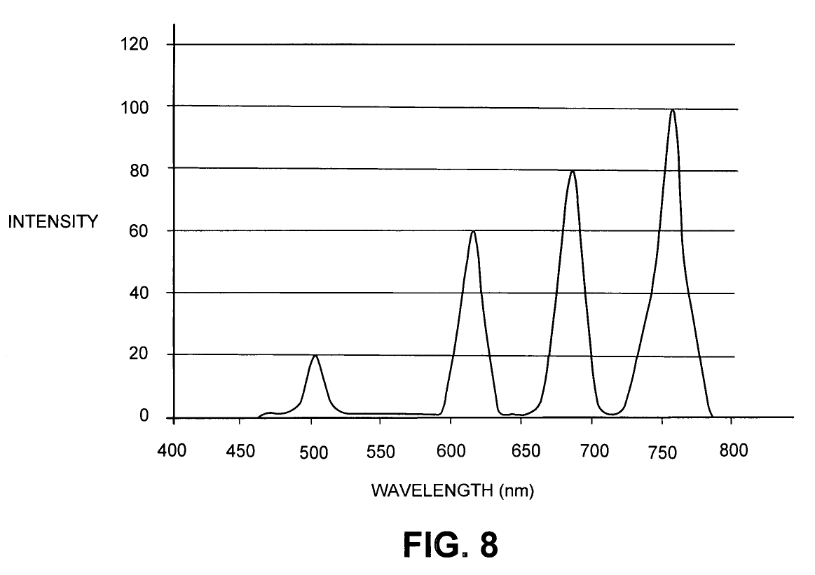

In some embodiments, it may be desirable to modify the luminescent signature of the postage stamps to increase the data-carrying capacity of the luminescent signature and/or to make the stamps still more resistant to counterfeiting. One way this may be done is to formulate the multispectral ink such that the intensities and/or the wavelength bands of the luminescent emissions vary depending on the wavelength of the radiation used to excite the ink. To support this modification, the postage verification apparatus 400 may be modified to excite the stamps in two phases with different wavelengths of excitation radiation. FIGS. 7 and 8 graphically illustrate two different luminescent radiation patterns that may be produced in response to different excitation radiation wavelengths by a multispectral ink provided in accordance with aspects of the present invention.

The order in which process steps are illustrated in the drawings and/or described herein is not intended to imply a fixed order for performing the process steps; rather, the process steps may be performed in any order that is practicable.

In some embodiments, a calibration card or the like may be printed with one or more regions of narrow-band/multispectral ink. The resulting card may be read by one or more embodiments of the luminescence reading devices described above to aid in calibration and/or testing of such devices.

To deal with cases in which postage is applied to a single mailpiece in the form of both a postage meter indicium and one or more pre-printed adhesive postage stamps, the postage verification apparatus may also include an optical character recognition and/or two-dimensional barcode reading capability to detect the denomination of meter indicia.

As a possible alternative to scanning mailpieces with relative movement between the mailpiece and the luminescence reader, a two-dimensional image of the mailpiece may be captured and algorithmically scanned to detect radiation from the luminescent signatures of stamps.

In embodiments described herein, postage stamp values are encoded on the stamps with ink that fluoresces in one or more selected wavelength bands. In addition or alternatively, multispectral and/or narrow-band phosphorescent ink may be used. In some embodiments, the ink may be both luminescent and phosphorescent (as disclosed, for example, in U.S. Pat. No. 5,569,317, commonly assigned herewith), and/or may include any material that emits radiation in a narrow wavelength band.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A postage verification apparatus, comprising:
reading means for reading a luminescent signature of a postage stamp to detect a value of the postage stamp;
weighing means for weighing a mailpiece to which the postage stamp is affixed; and
processing means, responsive to the reading means and the weighing means, for determining whether a required amount of postage has been affixed to the mailpiece.

2. The postage verification apparatus according to claim 1, wherein the luminescent signature of the postage stamp includes a coded representation of the value of the postage stamp.

3. The postage verification apparatus according to claim 2, wherein the coded representation includes a binary code.

4. The postage verification apparatus according to claim 2, wherein the reading means detects that the postage stamp exhibits luminescence in at least one wavelength band and that the postage stamp does not exhibit luminescence in at least one other wavelength band.

5. The postage verification apparatus according to claim 1, further comprising:
measuring means for measuring at least one dimension of the mailpiece;
wherein the processing means is also responsive to the measuring means in determining whether the required amount of postage has been affixed to the mailpiece.

6. The postage verification apparatus according to claim 1, further comprising:
address reading means for reading at least a portion of an address field on the mailpiece;
wherein the processing means determines whether the required amount of postage has been affixed to the mailpiece based in part on address information generated by the address reading means.

7. A method comprising:
reading a luminescent signature of a postage stamp to detect a value of the postage stamp;
weighing a mailpiece to which the postage stamp is affixed to determine a weight of the mailpiece; and
determining, based at least in part on the detected value of the postage stamp and the weight of the mailpiece, whether a required amount of postage has been affixed to the mailpiece.

8. The method according to claim 7, further comprising:
measuring at least one dimension of the mailpiece;
and wherein the determination of whether the required amount of postage has been affixed is based in part on the measured at least one dimension of the mailpiece.

9. The method according to claim 7, wherein the reading includes examining the postage stamp for presence or absence of luminescence in each of a plurality of wavelength bands.

10. The method according to claim 9, wherein each of the wavelength bands has a bandwidth that does not exceed about 50 nm.

11. The method according to claim 10, wherein each of the wavelength bands has a bandwidth of substantially 20 nm.

12. The method according to claim 7, further comprising:
reading at least a portion of an address field on the mailpiece;
and wherein the determining whether the required amount of postage has been affixed is based at least in part on information read from the address field.

13. A postage verification apparatus, comprising:
transport means for transporting mailpieces seriatim;
excitation means for applying excitation radiation to postage stamps affixed to the mailpieces;
a prism for receiving, and dispersing by wavelength, multispectral luminescence radiation emitted by the postage stamps in response to application of the excitation radiation;
sensor means for receiving and detecting the multispectral luminescence radiation dispersed by the prism; and
processing means, coupled to the sensor means, for detecting wavelength bands of the multispectral luminescence radiation received by the sensor means.

14. The postage verification apparatus according to claim 13, wherein the processing means detects said wavelength bands based at least in part on respective locations on the sensor means at which the dispersed multispectral luminescence radiation is received.

15. The postage verification apparatus according to claim 13, further comprising means for rotating the prism.

16. The postage verification apparatus according to claim 15, further comprising means for detecting an instantaneous rotational position of the prism.

17. The postage verification apparatus according to claim 13, further comprising:
weighing means, coupled to said processing means, for weighing said mailpieces and for supplying weight data to the processing means, said weight data indicating respective weights of said mailpieces;
and wherein the processing means is operative to:
detect values of said postage stamps based on the detected wavelength bands; and
determine, based at least in part on said weight data and said detected values, whether required amounts of postage have been affixed to the mailpieces.

18. The postage verification apparatus according to claim 17, further comprising:
measuring means, coupled to said processing means, for measuring at least one dimension of the mailpieces;
and wherein the processing means determines whether required amounts of postage have been affixed to the mailpieces based in part on the measured at least one dimension of the mailpieces.
